(19) United States
(12) Patent Application Publication
(10) Pub. No.: US 2014/0064514 A1
(43) Pub. Date: Mar. 6, 2014

(54) TARGET SOUND ENHANCEMENT DEVICE AND CAR NAVIGATION SYSTEM

(71) Applicants: Takashi Mikami, Tokyo (JP); Atsuyoshi Yano, Tokyo (JP)

(72) Inventors: Takashi Mikami, Tokyo (JP); Atsuyoshi Yano, Tokyo (JP)

(73) Assignee: MITSUBISHI ELECTRIC CORPORATION, Tokyo (JP)

(21) Appl. No.: 13/992,055

(22) PCT Filed: May 24, 2011
(86) PCT No.: PCT/JP2011/002890

§ 371 Date: Jun. 6, 2013

(51) Int. Cl. H04R 3/00

(52) U.S. Cl. CPC H04R 3/005
USPC 381/86

(57) ABSTRACT

A target sound enhancement device 10 has a first beamformer 16 and a second beamformer 17 which are of different types. A vehicle interior environment model in which this target sound enhancement device 10 is mounted is stored in a vehicle interior environment model storage unit 13. A beamformer type determining unit 14 selects a most suitable beamformer according to the vehicle interior environment model for each of predetermined frequency bands, and a BF selector 15 outputs a signal in each frequency band to the beamformer selected. A signal combining unit 18 combines signals in the frequency bands in each of which the driver's voice outputted from the first beamformer 16 or the second beamformer 17 is enhanced.

### FIELD OF THE INVENTION

The present invention relates to a target sound enhancement device that generates a sound signal in which a target sound is enhanced from output signals of a microphone array, and a car navigation system using this target sound enhancement device.

### BACKGROUND OF THE INVENTION

For example, in order to construct a calling system, such as a vehicle-mounted handsfree calling system, in an environment where a loud noise exists, such as a vehicle cabin, or an environment where a plurality of signal sources exist, it is necessary to provide a technology of separating and extracting only a signal from a specific signal source (speaker). A beamformer is provided as an example of such a technology. Beamformers enhance a signal in a target direction by combining signals of multiple channels acquired by a microphone array, and include fixed beamformers and adaptive beamformers. The simplest fixed beamformer is a Delay and Sum one, and adaptive beamformers include maximum likelihood (ML) beamformers, minimum variance distortionless response (MVDR) beamformers, and generalized sidelobe cancelers (GSC) (e.g., refer to nonpatent reference 1).

The Delay and Sum is a method of orienting the directivity of the microphone sensitivity toward a target direction. A problem with the Delay and Sum is that while the Delay and Sum generally has a small amount of computation, the sidelobe is large, the Delay and Sum is sensitive to a reverberation environment, and no adequate directivity is acquired for a low frequency range when there is a limit on resources, such as a purpose of mounting the method in a vehicle. In order to improve the directivity in a low frequency range, it is necessary to lengthen the array length of the entire microphone array. For example, in order to provide the main lobe with directivity of about ±10 degrees for a 1,000-Hz sound, the entire microphone array has to have an array length of about 2 m. Further, even if the array length is increased by simply lengthening the gap between microphones, a grating lobe occurs in a direction other than the target direction, and the directivity decreases (e.g., refer to nonpatent reference 2). Therefore, in order to maintain the directivity in a low frequency range while preventing a grating lobe from occurring, it is necessary to arrange many microphones densely, and therefore the cost increases.

On the other hand, a problem with adaptive beamformers is that although they form the directivity that makes a noise sound source be located at a dead angle while maintaining the sensitivity of the target direction constant, and they are effective also to a low frequency range and can reduce the noise also under a reverberation environment, they need a large amount of computation and do not have an adequate effect on diffusive noise.

Therefore, in order to implement a high sound source separation capability with a small number of microphones, for example, patent reference 1 discloses a method of preparing a plurality of beamformers. By applying these beamformers to each frequency band, and using an output having the largest amplitude of a beamformer for each frequency band according to the results of the application to combine the output for each frequency band, the sound source separation capability is improved and the speech recognition accuracy is also improved. Further, for example, patent reference 2 proposes a generic beamformer that optimally covers an angle section range in a specified region by using a plurality of beamformers from the beam width of each of the beamformers, an environmental noise model, etc. for each frequency band.

### RELATED ART DOCUMENT

### Patent References

Patent reference 1: Japanese Patent No. 4457221
Patent reference 2: Japanese Unexamined Patent Application Publication No. 2005-253071

### Nonpatent References

Nonpatent reference 1: Futoshi Asano, “Array signal processing for acoustics: localization, tracking and separation of sound sources”, Corona Publishing Co., Ltd., 2011, p 69-106 Nonpatent reference 2: Toshiro Oga, Yoshio Yamazaki, and Yutaka Kaneda, “Sound system and digital processing”, Institute of Electronics, Information and Communication Engineers, 1995, p 181-186

### SUMMARY OF THE INVENTION

### Problems to be Solved by the Invention

The methods disclosed in above-mentioned patent references 1 and 2 are aimed at pursuing the versatility. A problem is therefore that when a signal having the largest amplitude is selected from signals acquired from a plurality of beamformers, as shown in above-mentioned patent reference 1, a noise source is selected according to the method disclosed in above-mentioned patent reference 1 when the noise has power close to that of a voice, such as in the interior of a vehicle. Further, because the method disclosed in above-mentioned patent reference 2 is not aimed at optimally enhancing a target sound coming from a specific direction, a further improvement is required in order to optimally enhance a speaker's voice in the interior of a vehicle.

The present invention is made in order to solve the above-mentioned problem, and it is therefore an object of the present invention to provide a technique of switching among plural types of beamformers on a per frequency band basis according to a vehicle interior environment model to optimally enhance a sound signal resulting from a speaker' voice in the interior of a vehicle.

### Means for Solving the Problem

In accordance with the present invention, there is provided a target sound enhancement device including: an operation unit for converting output signals from two or more microphones mounted in the interior of a vehicle into signals in a frequency domain; a beamformer group having two or more different types of beamformers each for generating a signal including an enhanced target sound for each predetermined frequency band from the plural signals in the frequency domain into which the output signals are converted by the operation unit; a vehicle interior environment model storage unit for holding information about noise characteristics for each predetermined frequency band in the vehicle interior environment, and directional characteristics of each of the beamformers; a beamformer type determining unit for evaluating each of the beamformers for each predetermined frequency band on a basis of the directional characteristics and the noise characteristics held by the vehicle interior environment model storage unit to select a beamformer having a highest level of evaluation from the beamformers; an output switching unit for outputting the signals in the frequency domain into which the output signals are converted by the operation unit in units of each predetermined frequency band to the beamformer selected by the beamformer type determining unit; and a signal combining unit for combining the signals in the predetermined frequency bands outputted by the beamformer group.

In accordance with the present invention, there is provided a car navigation system including: two or more microphones mounted in the interior of a vehicle; the above-mentioned target sound enhancement device for generating a sound signal in which a speaker's voice in the interior of the vehicle is enhanced by using an output signal from each of the microphones as an input; and a handsfree call control unit for making a handsfree phone call by using the sound signal generated by the target sound enhancement device.

### Advantages of the Invention

In accordance with the present invention, because each of the beamformers is evaluated for each frequency band on the basis of the acoustic characteristics in the vehicle interior environment, and a target sound is enhanced by using the most suitable beamformer, a sound signal resulting from a speaker's voice in the interior of the vehicle can be enhanced optimally.

### BRIEF DESCRIPTION OF THE FIGURES

FIG. 1 is a block diagram showing the structure of a car navigation system to which a target sound enhancement device in accordance with Embodiment 1 of the present invention is applied;

FIG. 2 is a flow chart showing the operation of the target sound enhancement device in accordance with Embodiment 1;

FIG. 3 is a diagram for explaining a vehicle interior environment model which the target sound enhancement device in accordance with Embodiment 1 has;

FIG. 4 is a graph showing an example of first beamformer directional characteristics which the target sound enhancement device in accordance with Embodiment 1 has;

FIG. 5 is a graph showing an example of estimated vehicle interior noise power which the target sound enhancement device in accordance with Embodiment 1 has;

FIG. 6 is a flow chart explaining a beamformer type determining process carried out by the target sound enhancement device in accordance with Embodiment 1;

FIG. 7 is a diagram explaining another example of the vehicle interior environment model which the target sound enhancement device in accordance with Embodiment 1 has;

FIG. 8 is a block diagram showing the structure of a car navigation system to which a target sound enhancement device in accordance with Embodiment 2 of the present invention is applied;

FIG. 9 is a block diagram showing the structure of a car navigation system to which a target sound enhancement device in accordance with Embodiment 3 of the present invention is applied;

FIG. 10 is a diagram for explaining a vehicle interior environment model which the target sound enhancement device in accordance with Embodiment 3 has;

FIG. 11 is a flow chart explaining a beamformer type determining process carried out by the target sound enhancement device in accordance with Embodiment 3;

FIG. 12 is a flow chart explaining a beamformer type determining process carried out by a target sound enhancement device in accordance with Embodiment 4 of the present invention;

FIG. 13 is a block diagram showing the structure of a car navigation system to which a target sound enhancement device in accordance with Embodiment 5 of the present invention is applied;

FIG. 14 is a diagram for explaining a vehicle interior environment model which the target sound enhancement device in accordance with Embodiment 5 has; and

FIG. 15 is a flow chart explaining a beamformer type determining process carried out by the target sound enhancement device in accordance with Embodiment 5.

### EMBODIMENTS OF THE INVENTION

Hereafter, in order to explain this invention in greater detail, the preferred embodiments of the present invention will be described with reference to the accompanying drawings.

### Embodiment 1

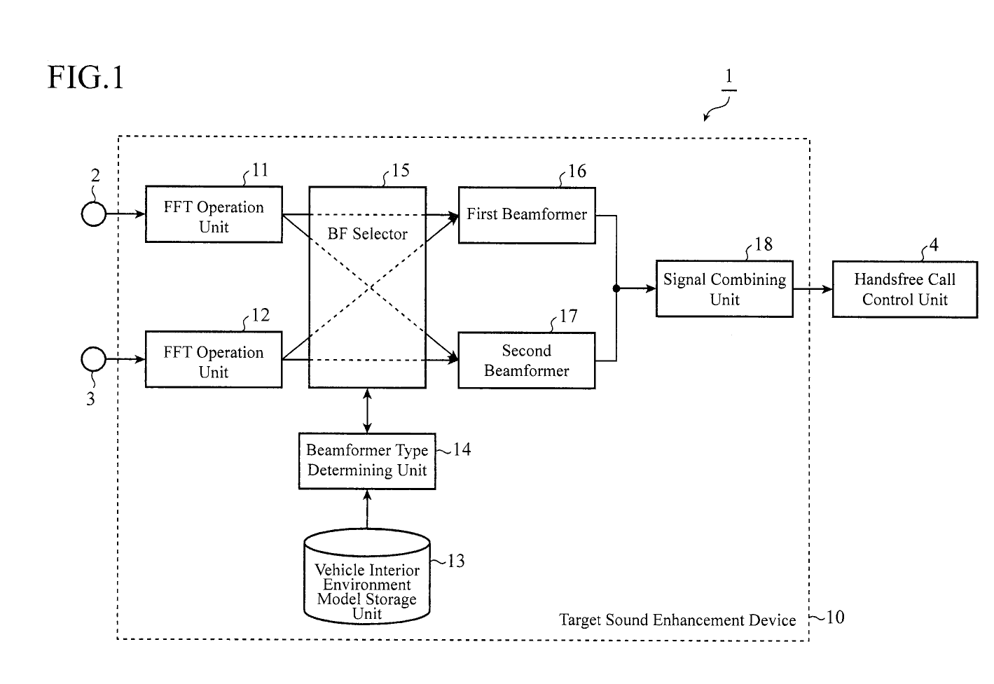

A car navigation system 1 shown in FIG. 1 includes a microphone array provided with microphones 2 and 3 each for recording a sound signal showing a sound in the interior of a vehicle and converting the sound signal into an electric signal, a target sound enhancement device 10 for enhancing a target sound by using output signals of these microphones 2 and 3 as its input, a handsfree call control unit 4 for carrying out a handsfree phone call by using (transmitting) a sound signal showing the enhanced target sound, and a navigation control unit (not shown) for carrying out a route search and guidance. In this car navigation system 1, the microphones 2 and 3 are arranged at a gap of about 10 cm between them, and can be mounted to a rearview mirror or the like in the interior of the vehicle. Further, a target sound which is enhanced by the target sound enhancement device 10 is the driver's voice, and therefore the target direction of the target sound enhancement device is a direction of the driver's seat. Further, although the number of microphones is two in the illustrated example, the number of microphones can be three or more because a beamformer can typically handle two or more channels of inputs. In this Embodiment 1, for the sake of simplicity, an explanation will be made by taking the case of using the two microphones 2 and 3 as an example.

The target sound enhancement device 10 is provided with FFT (Fast Fourier Transform) operation units 11 and 12, a vehicle interior environment model storage unit 13, a beamformer type determining unit 14, a BF (BeamFormer) selector (output switching unit) 15, a first beamformer 16, a second beamformer 17, and a signal combining unit 18.

The FFT operation unit 11 converts the output signal of the microphone 2 in a time domain into a signal in the frequency domain by using an FFT, and outputs this signal to the BF selector 15. Similarly, the FFT operation unit 12 converts the output signal of the microphone 3 in a time domain into a signal in the frequency domain, and outputs this signal to the BF selector 15. The method of converting the output signal into a signal in the frequency domain is not limited to the FFT. Further, the FFT operation units have only to be provided in the same number as the number of microphones which the car navigation system 1 has, and the number of FFT operation units is not limited to two in the illustrated example.

The vehicle interior environment model storage unit 13 is a memory for holding modelized noise characteristics of a vehicle interior environment of a specific type of vehicle. The beamformer type determining unit 14 determines the beamformer type that should be applied to a signal in each predetermined frequency band outputted from the BF selector 15 according to the vehicle interior environment model held by the vehicle interior environment model storage unit 13. The BF selector 15 divides the signal in the frequency domain which is outputted from each of the FFT operation units 11 and 12 into signals in predetermined frequency bands and outputs these signals to the beamformer type determining unit 14, and also outputs each of the signals divided to the beamformer to which the signal should be applied on the basis of the result of the determination by the beamformer type determining unit 14.

The first beamformer 16 and the second beamformer 17 are of different types, and each of the beamformers carries out a beamforming process on a signal in a frequency band outputted from the BF selector 15. In this embodiment, a Delay and Sum beamformer which is a fixed beamformer is used as the first beamformer 16, and a minimum variance distortionless response beamformer which is an adaptive beamformer is used as the second beamformer 17. Because the Delay and Sum and the minimum variance distortionless response are known techniques, the detailed explanation of these techniques will be omitted.

The signal combining unit 18 combines the signals in the frequency bands outputted from the first and second beamformers 16 and 17 to generate a signal, and converts this signal into a signal in a time domain by using an inverse FFT or the like to reconstruct a sound signal.

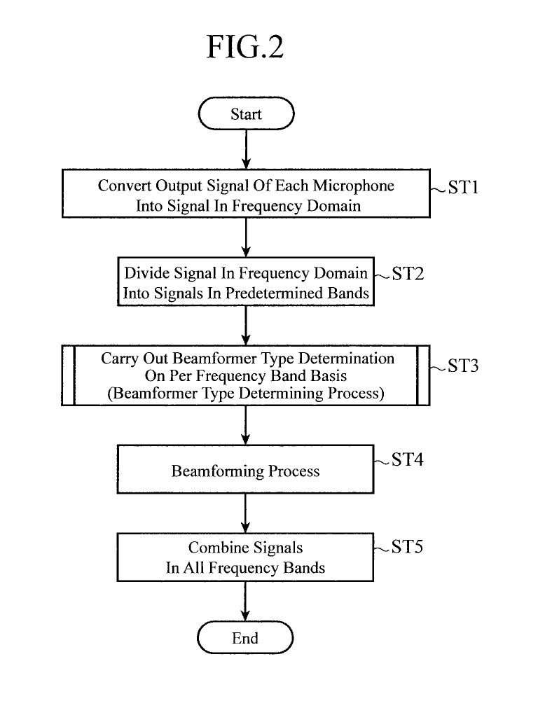

Next, the operation of the target sound enhancement device 10 will be explained with reference to a flow chart shown in FIG. 2. The FFT operation units 11 and 12 convert the output signals of the microphones 2 and 3 into signals in the frequency domain, respectively, and output the signals to the BF selector 15 (step ST1). The BF selector 15 divides each of the signals in the frequency domain into signals in predetermined frequency bands, and outputs each of the signals in predetermined frequency bands (e.g., in ascending order of frequency bands) to the beamformer type determining unit 14 (step ST2). The beamformer type determining unit 14 determines the beamformer type that should be applied to the signal in each frequency band provided thereto from the BF selector 15 according to the vehicle interior environment model held by the vehicle interior environment model storage unit 13 (step ST3). The details of a method of determining the beamformer type will be mentioned below.

When receiving the result of the determination of the beamformer type which should be applied to the signal in each frequency band which is a target for processing from the beamformer type determining unit 14, the BF selector 15 outputs the signal in each frequency band to either the first beamformer 16 or the second beamformer 17 which the BF selector has selected according to the determination result. The selected beamformer which is either the first beamformer 16 or the second beamformer 17 carries out the beamforming process on the inputted signal in each frequency band which is the target for processing (step ST4). Finally, the signal combining unit 18 combines the signals in the frequency bands each of which is outputted from the first beamformer 16 or the second beamformer 17 to generate and output a sound signal including the enhanced target sound (i.e., the driver's voice) to the handsfree call control unit 4.

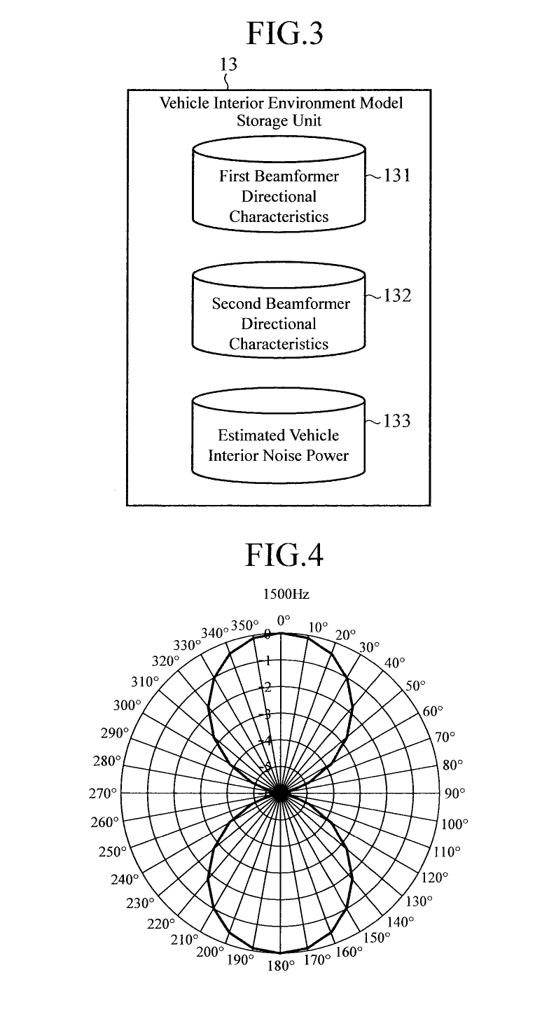

Next, the details of beamformer type determining processes will be explained. FIG. 3 is a diagram explaining the vehicle interior environment model held by the vehicle interior environment model storage unit 13. The vehicle interior environment model includes information 131 about the directional characteristics of the first beamformer 16 (referred to as the first beamformer directional characteristics from here on), information 132 about the directional characteristics of the second beamformer 17 (referred to as the second beamformer directional characteristics from here on), and information about estimated vehicle interior noise power 133.

The first beamformer directional characteristics 131 are information showing the directional characteristics of the interior of the target vehicle for each frequency band of the first beamformer 16. Because the first beamformer 16 is a Delay and Sum one, when a voice in the interior of the target vehicle can be approximated by a plane wave, the directional characteristics of the first beamformer can be determined as shown in the following equation (1).

$$G ( θ ) = \vert \frac{sin ( Ω M / 2 )}{sin ( Ω / 2 )} \vert \\ Ω = 2 π fd ( sin {θ}_{L} - sin θ ) / c \qquad ( 1 )$$

where θ_{L} is the angle in the target direction, d is the gap between the microphones (in this example, 10 cm), M is the number of microphones (in this example, two), f is the frequency, and c is the velocity of sound.

What is necessary is just to determine the sensitivity in the direction of 0 according to the above equation (1) and also determine a main lobe width in the target direction of θL for each frequency, and pre-set the sensitivity and the main lobe width to the vehicle interior environment model storage unit 13. FIG. 4 is a graph showing an example of the directional characteristics of the first beamformer 16 at the frequency f=1,500 Hz. In the graph, the radius from the center at each angle shows the size of the gain of the beamformer at the angle.

On the other hand, when the interior of the vehicle has a complicated shape and the driver's voice cannot be approximated by a plane wave, what is necessary is just to measure the directional characteristics by experiment in advance and set the directional characteristics to the vehicle interior environment model storage unit 13. In order to measure the directional characteristics, the target sound enhancement device has only to send out a sweep signal, such as a TSP (Time Stretched Pulse) signal, from a predetermined position, and process a sound signal recorded by each of the microphones 2 and 3 by using the first beamformer 16 to set the power of the sound signal to the vehicle interior environment model storage unit 13. The predetermined position at this time is a position with each predetermined angle at a point on a circle having a radius of 50 cm centered at each of the microphones 2 and 3.

Further, because the second beamformer 17 is an adaptive minimum variance distortionless response one, the target sound enhancement device has only to determine the directional characteristics by carrying out a measurement as mentioned above, and pre-set the directional characteristics to the vehicle interior environment model storage unit 13 as the second beamformer directional characteristics 132.

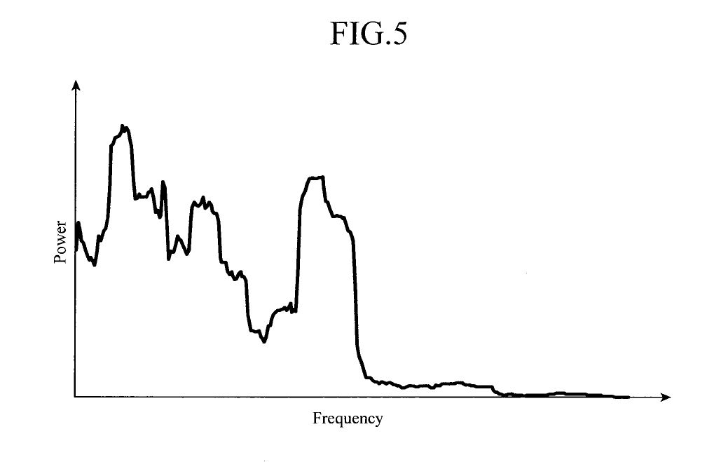

The estimated vehicle interior noise power 133 is information showing the average noise power in the interior of the target vehicle as a function of frequency. FIG. 5 is a graph showing an example of the estimated vehicle interior noise power 133. By using this estimated vehicle interior noise power 133, the target sound enhancement device can estimate the noise power at a specific frequency in the interior of the target vehicle.

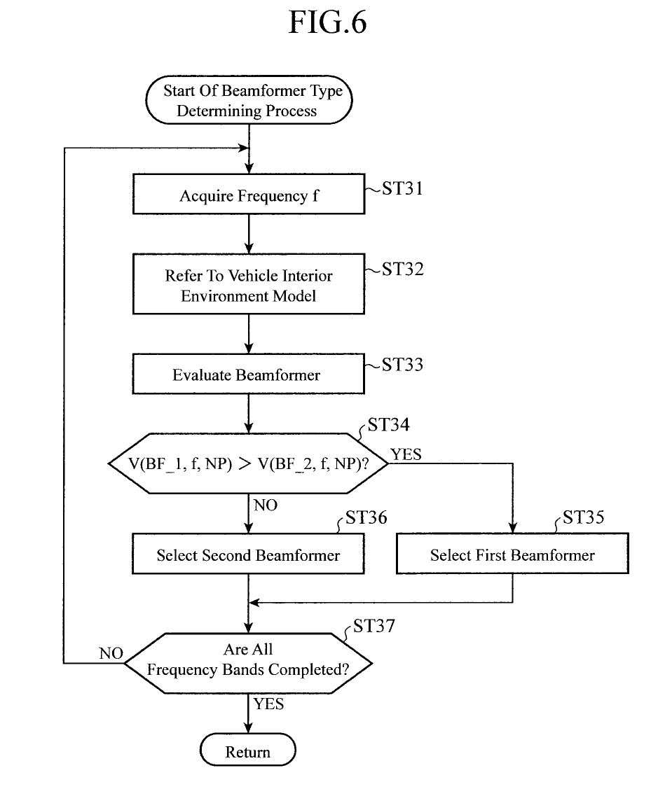

FIG. 6 is a flow chart showing the details of the beamformer type determining processes (corresponding to step ST3 of FIG. 2) carried out by the beamformer type determining unit 14. The beamformer type determining unit 14 receives a signal having a frequency (or frequency band) f outputted from the BF selector 15 (step ST31), and carries out the following process to determine the type of the beamformer which should be applied to this frequency f (the first beamformer 16 or the second beamformer 17).

The beamformer type determining unit 14 acquires the first beamformer directional characteristics 131, the second beamformer directional characteristics 132, and the estimated vehicle interior noise power 133, which correspond to the frequency f, from the vehicle interior environment model storage unit 13 (step ST32). The beamformer type determining unit then evaluates the first beamformer 16 according to a predetermined evaluation equation by using the first beamformer directional characteristics 131 and the estimated vehicle interior noise power 133, and also evaluates the second beamformer 17 according to a predetermined evaluation equation by using the second beamformer directional characteristics 132 and the estimated vehicle interior noise power 133 to calculate their respective evaluated values (step ST33).

Each of the evaluation equations has a form of V(BF, f, NP), and is a function of the beamformer type BF (the type of the first beamformer 16 is expressed as BF_{—}1 and the type of the second beamformer 17 is expressed as BF_{—}2), the frequency f, and the estimated noise power NP. In this embodiment, for example, the evaluation equation for the first beamformer 16 is given by the following equation (2) and the evaluation equation for the second beamformer 17 is given by the following equation (3).

$$\begin{matrix}\begin{matrix}V ( BF\_ 1 , f , NP ) = V\_BF \_ 1 ( f ) \\ = 1 / ( the main lobe width at the frequency f \\ of the first beamformer 16 )\end{matrix} & ( 2 ) \\ \begin{matrix}V ( BF\_ 2 , f , NP ) = V\_BF \_B ( f , NP ) \\ = \{ NP / ( a reference value ) \} / \\ ( the main lobe width at the frequency f \\ of the second beamformer 17 )\end{matrix} & ( 3 )\end{matrix}$$

In this case, the main lobe width is defined as the width at an angle θ centered at the target direction in which the gain value is equal to or smaller than a predetermined value with respect to that in the target direction. Because the main lobe width is defined in this way, one of the beamformers that has a narrower main lobe width (i.e., that has a higher degree of directivity in the target direction) has a higher evaluated value. Further, by setting the reference value appropriately, the higher the noise level, the higher evaluated value the second beamformer 17 has, and the lower the noise level, the higher evaluated value the first beamformer 16 has. This is because a minimum variance distortionless response beamformer which is used as the second beamformer 17 has a property of its ability degrading easily when the noise level is low.

The beamformer type determining unit 14 compares the evaluated value of the first beamformer 16 with the evaluated value of the second beamformer 17 (step ST34), and, when the evaluated value of the first beamformer 16 is equal to or higher than that of the second beamformer, selects the first beamformer 16 and notifies the selection to the BF selector 15 (step ST35), whereas when the evaluated value of the second beamformer 17 is higher than that of the first beamformer, the beamformer type determining unit selects the second beamformer 17 and notifies the selection to the BF selector 15 (step ST36). The BF selector 15 outputs the signal of the frequency f to the selected beamformer in response to the notification of step ST36.

When completing the process of determining the beamformer type on the signals in all the frequency bands outputted from the BF selector 15 (i.e., the signals in the frequency domain each of which is outputted from the FFT operation unit 11 or 12) (when “YES” in step ST37), the beamformer type determining unit 14 ends the series of beamformer type determining processes. In contrast, when there is a frequency on which the beamformer type determining unit has not carried out the determining processes yet (when “NO” in step ST37), the beamformer type determining unit returns to step ST31 again.

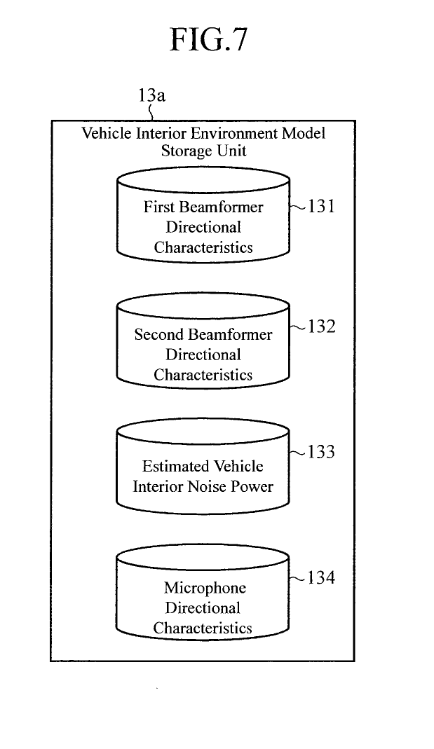

In the above-mentioned explanation, the example in which the beamformer type determining unit evaluates each beamformer by using the first beamformer directional characteristics 131 or the second beamformer directional characteristics 132, and the estimated vehicle interior noise power 133, which are stored in the vehicle interior environment model storage unit 13 shown in FIG. 3 is shown. However, the present invention is not limited to this evaluation method. For example, in an example of FIG. 7, the vehicle interior environment model storage unit 13a newly holds information 134 showing the directional characteristics of the microphones 2 and 3 for each frequency band (referred to as the microphone directional characteristics from here on). In this structure, the beamformer type determining unit 14 calculates an estimated SN (signal-to-noise) ratio from the ratio between the microphone directional characteristics and the beamformer directional characteristics for each frequency band in the beamformer evaluation process of step ST33. In this example, the evaluation equation for the first beamformer 16 is given by the following equation (4) and the evaluation equation for the second beamformer 17 is given by the following equation (5).

$$\begin{matrix}V ( BF\_ 1 , f , NP ) = V\_BF \_ 1 ( f ) \_ {\int }_{{θ}_{W}}^{ } {G}_{BF 1} ( θ , f ) d θ & ( 4 ) \\ \begin{matrix}V = ( BF\_ 2 , f , NP ) \\ = V\_BF \_ 2 ( f ) \\ = \frac{{\int }_{{θ}_{W}}^{ } {G}_{BF 2} ( θ , f ) d θ}{{\int }_{{θ}_{W}}^{ } {G}_{M} ( θ , f ) d θ}\end{matrix} & ( 5 )\end{matrix}$$

In the equations shown above, G_{M}(θ), G_{BF1}(θ), and G_{BF2}(θ) are gain values at the frequency f in the direction of the angle θ of each of the microphones 2 and 3, the first beamformer 16, and the second beamformer 17, respectively. θ_{W} is an angular area on which integration is carried out. Although the directional characteristics are acquired for 360 degrees, there is a case in which rear directional characteristics should not be taken into consideration because no sound source exists practically at the rear of each of the microphones. Therefore, θ_{W} is determined according to the vehicle interior environment of the target vehicle. As a result, a beamformer having sharp directional characteristics is easy to be selected. Further, like in the equation (3) shown above, the equation (5) can be multiplied by the ratio between the estimated noise power and the reference value.

As mentioned above, the target sound enhancement device 10 in accordance with Embodiment 1 is constructed in such a way as to include: the FFT operation units 11 and 12 for converting the output signals from the microphones 2 and 3 mounted in the interior of the vehicle into signals in the frequency domain; the beamformer group having the first beamformer 16 based on a Delay and Sum method and the second beamformer 17 based on a minimum variance distortionless response method, the first and second beamformers generating signals in each of which a voice coming from the direction of the driver's seat is enhanced for each predetermined frequency band from the two signals in the frequency domain into which the output signals are converted by the FFT operation units 11 and 12, respectively; the vehicle interior environment model storage unit 13 for holding the first beamformer directional characteristics 131, the second beamformer directional characteristics 132, and the estimated vehicle interior noise power 133; the beamformer type determining unit 14 for evaluating the first and second beamformers 16 and 17 on the basis of the first and second beamformer directional characteristics 131 and 132 and the estimated vehicle interior noise power 133 to select one of the beamformers having a higher degree of evaluation for each predetermined frequency band of each of the signals in the frequency domain into which the output signals are converted by the FFT operation units 11 and 12; the BF selector 15 for outputting the signal in each predetermined frequency band to the first beamformer 16 or the second beamformer 17 which is selected by the beamformer type determining unit 14; and the signal combining unit 18 for combining the signals in the predetermined frequency bands outputted by the beamformer group. Therefore, the target sound enhancement device changes the beamformer most suitable for the vehicle interior environment peculiar to the target vehicle on a per frequency basis to apply the beamformer to each frequency band, thereby being able to improve the SN ratio and optimally enhance a voice coming from the driver's seat. Further, the target sound enhancement device can easily carry out a setup of the most suitable beamformer by changing the vehicle interior environment model held by the vehicle interior environment model storage unit 13 according to the target vehicle.

Further, because a fixed beamformer with a low calculation cost is used as one beamformer in the beamformer group, the amount of computation can be reduced. In addition, because a minimum variance distortionless response beamformer whose capability degrades when the noise level is low is used as one beamformer in the beamformer group, the other Delay and Sum beamformer is easy to be selected when the evaluation equation used for the evaluation of the beamformer type is multiplied by the ratio between the estimated noise power and the reference value, like the evaluation equation (3). Therefore, the target sound enhancement device enables the different types of beamformers to compensate for their shortcomings.

Although the target sound enhancement device is constructed in such a way as to dynamically determine which one of the first beamformer 16 and the second beamformer 17 should be applied to each frequency band in above-mentioned Embodiment 1, this embodiment is not limited to this structure. Because the vehicle interior environment model storage unit 13 can store a static data set, the target sound enhancement device can determine which one of the beamformers should be applied to each frequency band according to the flow chart shown in FIG. 6, and produce and hold a table showing the beamformer type applied to each frequency band in the vehicle interior environment model storage unit.

Further, although the example in which the target sound enhancement device 10 is applied to the car navigation system 1 equipped with the handsfree call control unit 4 is explained in above-mentioned Embodiment 1, this embodiment is not limited to this application. For example, the target sound enhancement device can be constructed in such a way as to, when a voice recognition is carried out to make an input of a destination at a time of providing route guidance, record a voice saying a destination, which is uttered by the driver, by using the microphones 2 and 3 as pre-processing, and cause a voice recognition unit of the car navigation system 1 to use sound signals on which the target sound enhancement device 10 has carried out a beamforming process appropriately.

In addition, although the microphone array in which the gap between the microphones 2 and 3 is set to about 10 cm is used in the previously explained example, this gap is based on the premise that the microphone array is mounted in the interior of the vehicle and is not limited to 10 cm. However, although there is provided an advantage of achieving sharp directivity by using the Delay and Sum method (first beamformer 16) by lengthening the gap to some extent, it is necessary to set the gap to be a proper one because a sidelobe (grating lobe) occurs and hence the directivity is lost when the gap is too long.

### Embodiment 2

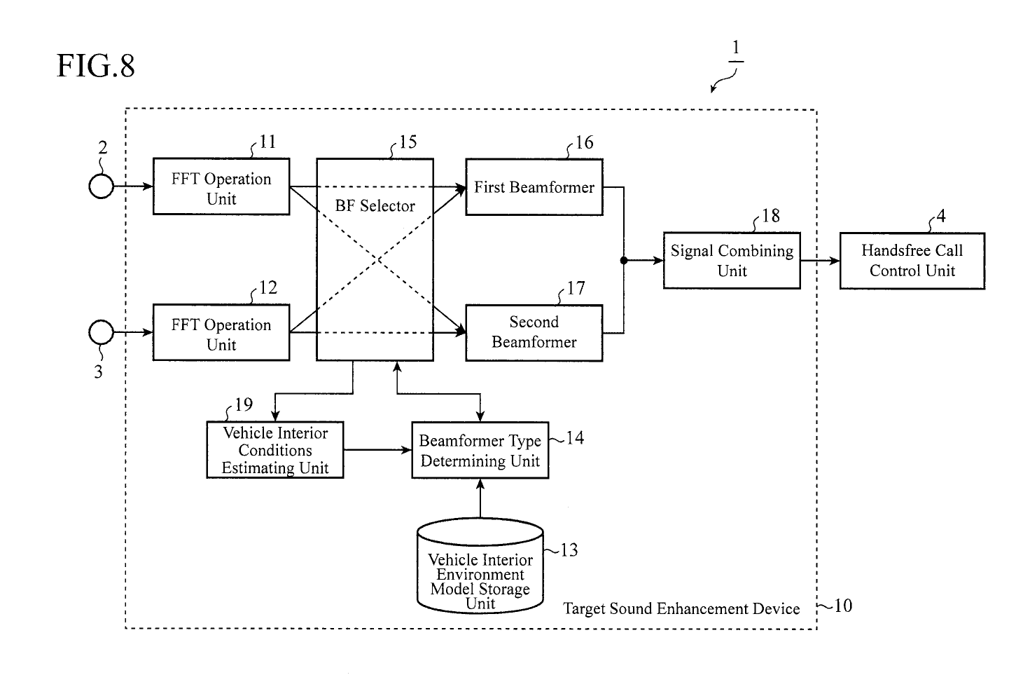

FIG. 8 is a block diagram showing the structure of a car navigation system 1 to which a target sound enhancement device 10 in accordance with this Embodiment 2 is applied. The target sound enhancement device 10 in accordance with this Embodiment is newly provided with a vehicle interior conditions estimating unit 19 for estimating current vehicle interior conditions from signals in the frequency domain inputted in a time series. In FIG. 8, the same components as those shown in FIG. 1 or like components are designated by the same reference numerals, and the explanation of the components will be omitted hereafter.

A BF selector 15 divides each of signals in the frequency domain outputted from FFT operation units 11 and 12 into signals in predetermined bands, and outputs each of the signals in the predetermined bands to a beamformer type determining unit 14 and the vehicle interior conditions estimating unit 19 in ascending order of frequency bands.

The vehicle interior conditions estimating unit 19 estimates the current vehicle interior conditions (estimated noise power of each frequency band) on the basis of the signal in each frequency band outputted from the BF selector 15, and outputs the current vehicle interior conditions to the beamformer type determining unit 14 as a conditions parameter. As a method of estimating noise power for use in the vehicle interior conditions estimating unit 19, the vehicle interior conditions estimating unit has only to detect a voice interval and a non-voice interval (i.e., noise section) from the signals in the frequency domain by using a known technique (for example, refer to Japanese Unexamined Patent Application Publication No. Hei 10-171487), and estimate noise power by calculating power from a signal in the detected noise section. Further, because the calculation of the estimated noise power differs according to each microphone, the vehicle interior conditions estimating unit 19 has only to use the average of the signals from the microphones 2 and 3, or selectively use one of the signals.

The beamformer type determining unit 14 determines a beamformer type suitable for the signal in each frequency band outputted from the BF selector 15 by using the estimated noise power for each frequency band outputted from the vehicle interior conditions estimating unit 19, instead of estimated vehicle interior noise power 133 held by a vehicle interior environment model storage unit 13 in advance. Therefore, the vehicle interior environment model storage unit 13 does not have to hold the estimated vehicle interior noise power 133 in advance.

As mentioned above, the target sound enhancement device 10 in accordance with Embodiment 2 is constructed in such a way that the target sound enhancement device includes the vehicle interior conditions estimating unit 19 for estimating the noise power in the vehicle interior environment by using the output signals of the microphones 2 and 3, and the beamformer type determining unit 14 uses the noise power estimated by the vehicle interior conditions estimating unit 19, instead of the estimated vehicle interior noise power 133 held by the vehicle interior environment model storage unit 13. Therefore, the target sound enhancement device can estimate noise from the current output signals, and select the beamformer type more suitable for the conditions.

### Embodiment 3

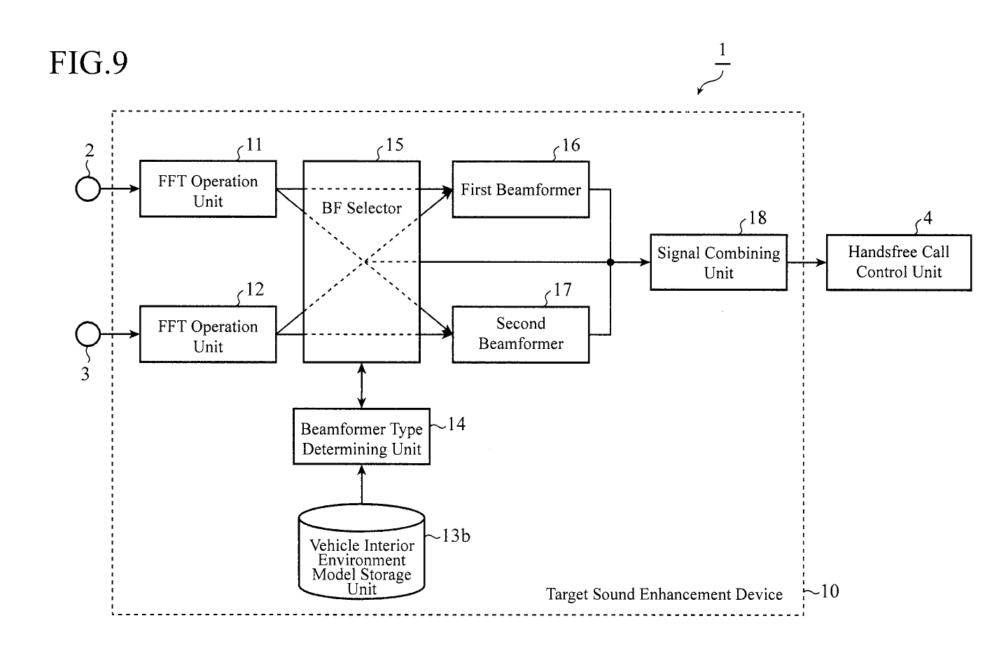

FIG. 9 is a block diagram showing the structure of a car navigation system 1 to which a target sound enhancement device 10 in accordance with this Embodiment 3 is applied. In FIG. 9, the same components as those shown in FIG. 1 or like components are designated by the same reference numerals, and the explanation of the components will be omitted hereafter.

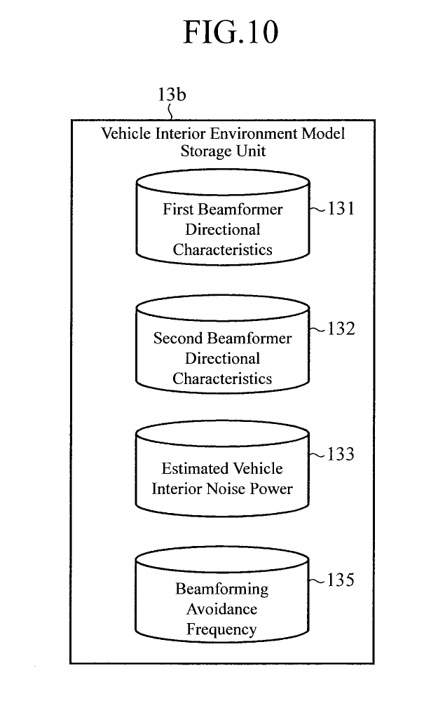

FIG. 10 is a diagram explaining a vehicle interior environment model held by a vehicle interior environment model storage unit 13b. This vehicle interior environment model storage unit 13b newly holds information about a beamforming avoidance frequency 135 in addition to the directional characteristics 131 of a first beamformer, the directional characteristics 132 of a second beamformer, and estimated vehicle interior noise power 133. This beamforming avoidance frequency 135 is information showing the frequency band of noise which does not have any variation among a plurality of microphones 2 and 3, such as noise caused by a vibration occurring in a vehicle part (an engine, audio equipment, or the like), and this noise cannot be reduced through beamforming. For example, there can be a case in which when the rearview mirrors to which the microphones 2 and 3 are mounted vibrate, there is a strong correlation between the output signals of the microphones 2 and 3, and an application of either the first beamformer 16 or the second beamformer 17 enhances the noise instead. The frequency band of such noise can be detected by experiment as characteristics according to the vehicle type of a target vehicle, and can be set to the vehicle interior environment model storage unit 13b as the beamforming avoidance frequency 135.

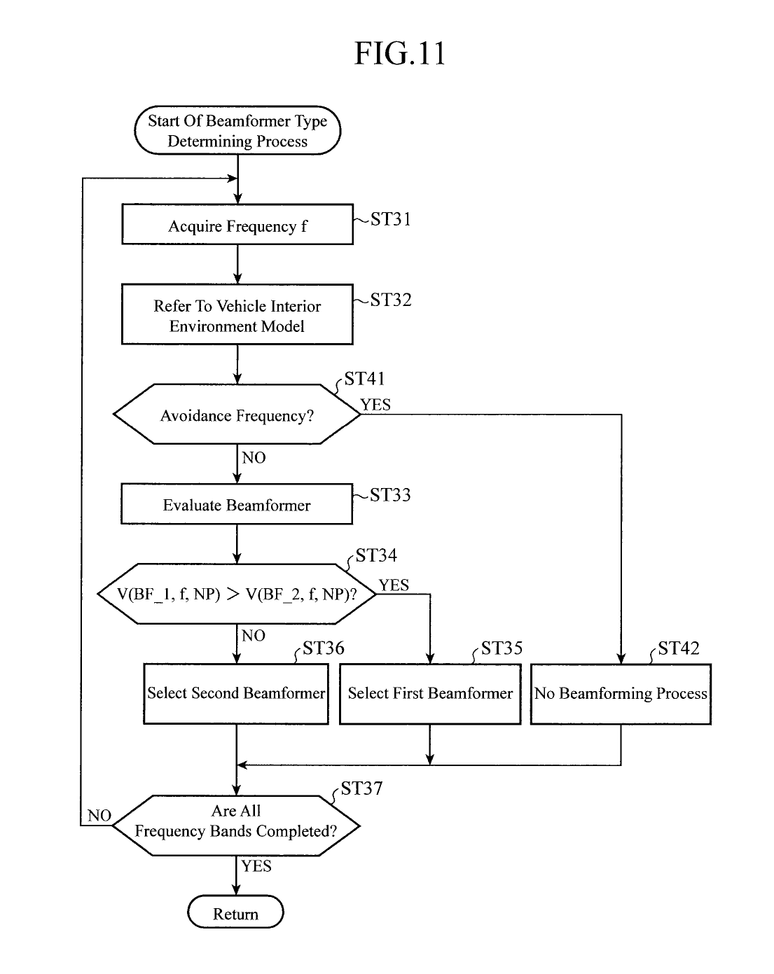

Next, the details of a beamformer type determining process carried out by a beamformer type determining unit 14 will be explained with reference to a flow chart shown in FIG. 11. Because processes of steps ST31 to ST37 shown in FIG. 11 are the same as those of steps ST31 to ST37 shown in FIG. 2, the explanation of the processes will be omitted hereafter, and processes of steps ST41 and ST42 will be explained mainly.

The beamformer type determining unit 14 determines whether or not a frequency (or frequency band) f which is a target for processing corresponds to the beamforming avoidance frequency 135 before carrying out a beamformer evaluation in step ST33 (step ST41). When the frequency f corresponds to the avoidance frequency (when “YES” in step ST41), the beamformer type determining unit 14 determines that there is no beamformer which should be applied to the frequency f, and notifies a BF selector 15 to that effect (step ST42). In contrast, when the frequency f does not correspond to the avoidance frequency (when “NO” in step ST41), the beamformer type determining unit selects one of the first beamformer 16 and the second beamformers 17 by carrying out processes of step ST33 following the step and subsequent steps. When receiving the notification showing that no beamforming process is carried out on the signal of the frequency f from the beamformer type determining unit 14, the BF selector 15 outputs the signal of the frequency f to a signal combining unit 18.

It is needless to say that when determining evaluated values for the first beamformer 16 and the second beamformer 17 by carrying out the processes of step ST33 and subsequent steps, the beamformer type determining unit can carry out the evaluation by using either microphone directional characteristics 134 or estimated noise power determined by a vehicle interior conditions estimating unit 19, instead of an evaluation method using the first beamformer directional characteristics 131, the second beamformer directional characteristics 132, and the estimated vehicle interior noise power 133.

As mentioned above, the target sound enhancement device 10 in accordance with Embodiment 3 is constructed in such a way that the target sound enhancement device stores the beamforming avoidance frequency 135 showing the frequency band in which to avoid the process using the first and second beamformers 16 and 17 in the vehicle interior environment model storage unit 13b, and the beamformer type determining unit 14 does not select any beamformer when a frequency band which is a target for the beamformer evaluation corresponds to the beamforming avoidance frequency 135 held by the vehicle interior environment model storage unit 13b, and the BF selector 15 outputs the signal of the frequency band for which the beamformer type determining unit 14 does not carry out the selection of a beamformer to the signal combining unit 18. Therefore, the target sound enhancement device can carry out a beamforming process which is more suitable for the target vehicle type.

### Embodiment 4

Because a target sound enhancement device 10 in accordance with this Embodiment 4 has the same structure as the target sound enhancement device 10 shown in FIG. 1 from a graphical viewpoint, the target sound enhancement device will be explained with reference to FIG. 1. In this Embodiment 4, an evaluation equation V′ (BF, f, NP) for evaluating a beamformer is defined by using the evaluation equation V(BF, f, NP) explained in above-mentioned Embodiment 1 as follows.

$$\begin{matrix}{V}^{′} ( BF , f , NP ) = VC ( BF , NP ) \cdot V ( BF , f , NP ) & ( 6 ) \\ In this equation , VC ( BF , NP ) = 1 - a ( BF ) \cdot \frac{Cost ( BF )}{NP} & ( 7 )\end{matrix}$$

As mentioned above, beamformer types BF include BF_{—}1 (a first beamformer 16) and BF_{—}2 (a second beamformer 17). Further, α(BF) is a coefficient parameter determined for each beamformer type, and 1 can be provided uniformly for all the beamformer types as α(BF). Further, Cost(BF) is a function of returning a corresponding calculation cost to each beamformer type. This function can be configured by creating a table including the calculation cost set for each beamformer type in advance and storing the table in a vehicle interior environment model storage unit 13 or the like.

It can be seen from the equation (7) shown above that the amount of computation is insignificant and VC(BF, NP) has a value close to 1 when the estimated noise power NP is large. Therefore, the evaluated value (6) for each beamformer is determined by the directional characteristics acquired from V(BF, f, NP). In contrast, when the estimated noise power NP is small, the degree of contribution of the calculation cost to the evaluated value increases, and the evaluated value for each beamformer is determined from the calculation cost.

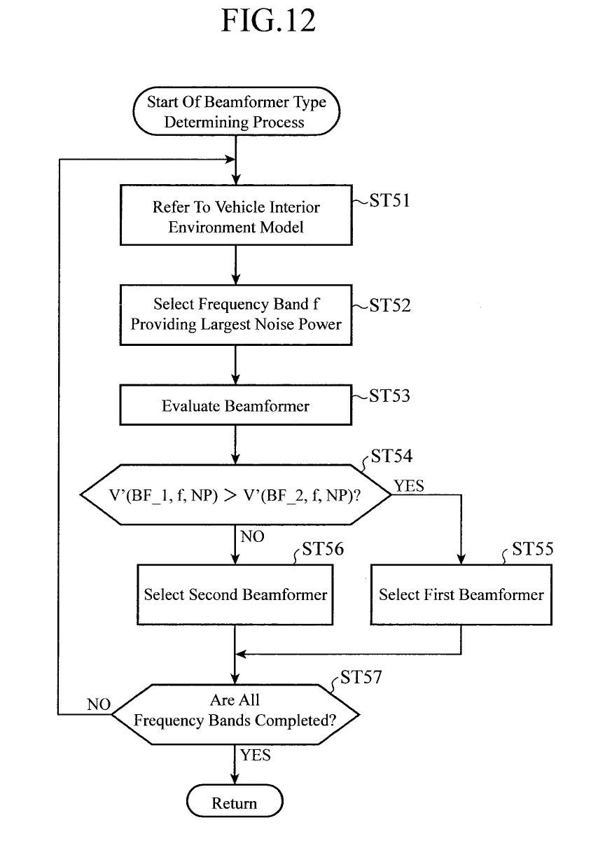

Next, the details of a beamformer type determining process carried out by a beamformer type determining unit 14 will be explained with reference to a flow chart shown in FIG. 12. This process corresponds to step ST3 shown in FIG. 2. The beamformer type determining unit 14 refers to estimated vehicle interior noise power 133 stored in a vehicle interior environment model storage unit 13 first (step ST51), and compares the estimated vehicle interior noise power with the estimated noise power of a signal in a frequency band, on which the determining process has not been carried out yet, among signals in the frequency domain outputted from a BF selector 15 to select a frequency band (or frequency) f which provides the largest estimated noise power (step ST52). More specifically, while the beamformer type determining process is carried out on each predetermined frequency band in ascending order of frequency bands in above-mentioned Embodiments 1 to 3, the beamformer type determining process is carried out on the predetermined frequency bands in descending order of their estimated noise power in this Embodiment 4.

The beamformer type determining unit 14 calculates an evaluated value for the first beamformer 16 and an evaluated value for the second beamformer 17 for the signal in the selected frequency band f according to the equation (6) shown above and by using the directional characteristics 131 of the first beamformer and the estimated vehicle interior noise power 133, and the directional characteristics 132 of the second beamformer and the estimated vehicle interior noise power 133 from the vehicle interior environment model storage unit 13 (step ST53). The beamformer type determining unit compares the evaluated values (step ST54), and, when the evaluated value of the first beamformer 16 is equal to or higher than that of the second beamformer, selects the first beamformer 16 and notifies the BF selector 15 to that effect (step ST55), whereas when the evaluated value of the second beamformer 17 is higher than that of the first beamformer, the beamformer type determining unit selects the second beamformer 17 and notifies the BF selector 15 to that effect (step ST56).

The beamformer type determining unit 14 then carries out the beamformer type determination in descending order of estimated noise power, and, when completing the beamformer type determination on the signals in all the frequency bands which are outputted from the BF selector 15 (when “YES” in step ST57), ends the series of beamformer type determining processes. In contrast, when there is a frequency band on which the determination has not been carried out yet (when “NO” in step ST57), the beamformer type determining unit returns to step ST51 again.

As mentioned above, the target sound enhancement device 10 in accordance with Embodiment 4 is constructed in such a way that the target sound enhancement device stores the information about the calculation costs respectively provided for the first and second beamformers 16 and 17 in the vehicle interior environment model storage unit 13 or the like, and the beamformer type determining unit 14 evaluates the first and second beamformers for each predetermined frequency band on the basis of the first beamformer directional characteristics 131, the second beamformer directional characteristics 132, the estimated vehicle interior noise power 133, and the calculation costs. The beamformer type determining unit 14 is further constructed in such a way as to refer to the estimated vehicle interior noise power 133 held by the vehicle interior environment model storage unit 13 to evaluate each beamformer for each of the frequency bands in descending order of their estimated noise power. Therefore, a beamformer type having a higher degree of appropriateness of directional characteristics is selected for a frequency band having large estimated noise power without being influenced by the amount of computation, while a beamformer type having a smaller amount of computation is selected for a frequency band which has small estimated noise power instead and which is hardly influenced by the directional characteristics of the beamformer, and the total amount of computation can be reduced without the performance being lowered greatly as a whole.

Although the calculation cost is taken into consideration from the ratio with the estimated noise power, as shown in the equation (7) shown above, in above-mentioned Embodiment 4, another evaluation equation having the calculation cost as a variable can be alternatively used. Further, when selecting the frequency bands in descending of their noise power, the beamformer type determining unit 14 can use noise power which the target sound enhancement device estimates in real time by using a vehicle interior conditions estimating unit 19, like that in accordance with above-mentioned Embodiment 2, instead of the estimated vehicle interior noise power 133 held by the vehicle interior environment model storage unit 13.

### Embodiment 5

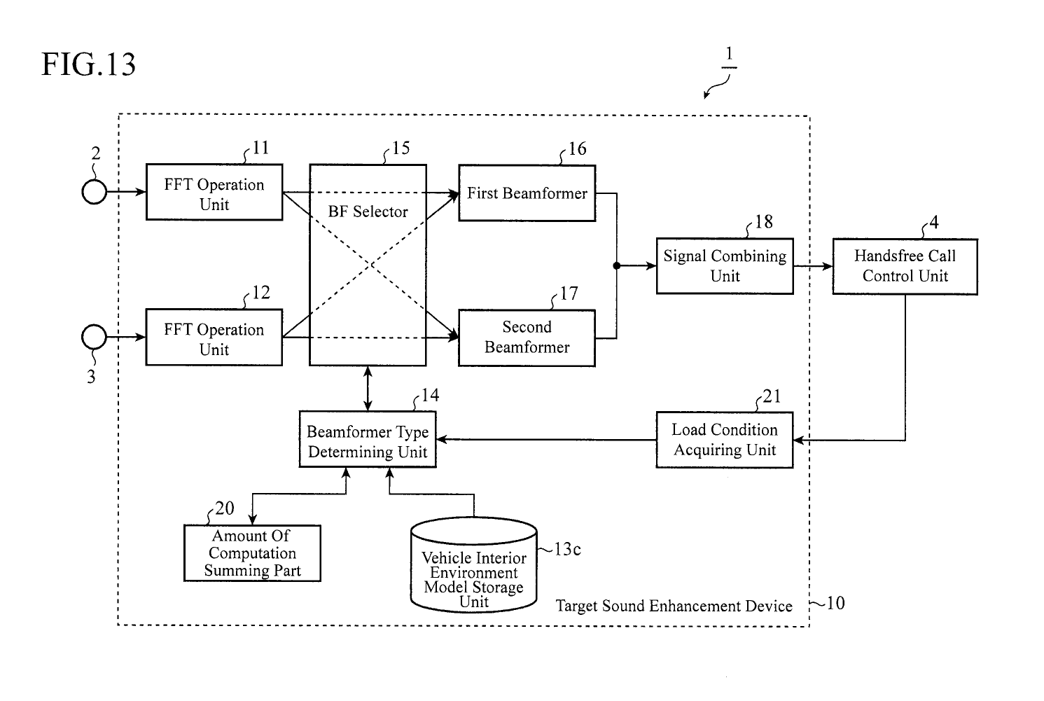

FIG. 13 is a block diagram showing the structure of a car navigation system 1 to which a target sound enhancement device 10 in accordance with this Embodiment 5 is applied. The target sound enhancement device 10 in accordance with this Embodiment 5 newly includes an amount of computation summing unit 20 for summing the amount of computation caused by a first beamformer 16 and the amount of computation caused by a second beamformer 17 for each frequency band, and a load conditions acquiring unit 21 for acquiring current CPU (Central Processing Unit) load conditions. In FIG. 13, the same components as those shown in FIG. 1 or like components are designated by the same reference numerals, and the explanation of the components will be omitted hereafter.

The target sound enhancement device 10 shown in FIG. 13 consists of a computer, and a program in which processes carried out by FFT operation units 11 and 12, a beamformer type determining unit 14, a BF selector 15, the first beamformer 16, the second beamformer 17, a signal combining unit 18, and the amount of computation summing unit 20 are described is stored in a memory of the computer and the CPU of the computer executes the program stored in the memory. Therefore, the FFT operation units 11 and 12, the beamformer type determining unit 14, the BF selector 15, the first beamformer 16, the second beamformer 17, the signal combining unit 18, and the amount of computation summing unit 20 affect the load conditions of the CPU. The load conditions acquiring unit 21 acquires the usage rate X [%] of this CPU.

Further, when the car navigation system 1 shares the CPU with the target sound enhancement device 10, other components, such as a handsfree call control unit 4, affect the usage rate X of the CPU which the load conditions acquiring unit 21 acquires.

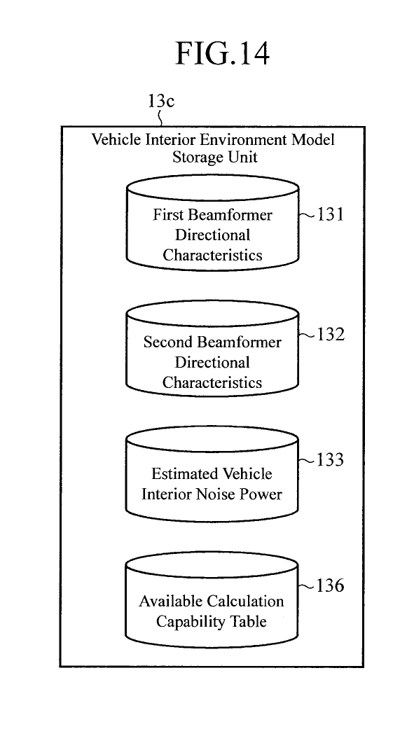

FIG. 14 is a diagram explaining a vehicle interior environment model held by a vehicle interior environment model storage unit 13c. This vehicle interior environment model storage unit 13c newly holds an available calculation capability table 136 in addition to the directional characteristics 131 of the first beamformer, the directional characteristics 132 of the second beamformer, and estimated vehicle interior noise power 133. This available calculation capability table 136 is information showing an available calculation capability according to the CPU usage which can be assigned to a beamformer group.

Hereafter, an example of the available calculation capability will be explained. In this Embodiment 4, the amount of computation in a case of applying a beamformer having the smallest calculation cost among the beamformers which the target sound enhancement device 10 has to each of all the frequency bands is expressed as MinCost, and the difference between this MinCost and the calculation cost set for the beamformer group is defined as the available calculation capability. In this Embodiment 4, because the first beamformer 16 using a Delay and Sum method of fixed type has the smallest calculation cost, this calculation cost can be expressed as MinCost. Therefore, the available calculation capability table 136 is equivalent to a table that holds the calculation cost set for the second beamformer 17 as the available calculation capability. What is necessary is just to generate this table as a parameter in advance and store the table in the vehicle interior environment model storage unit 13c.

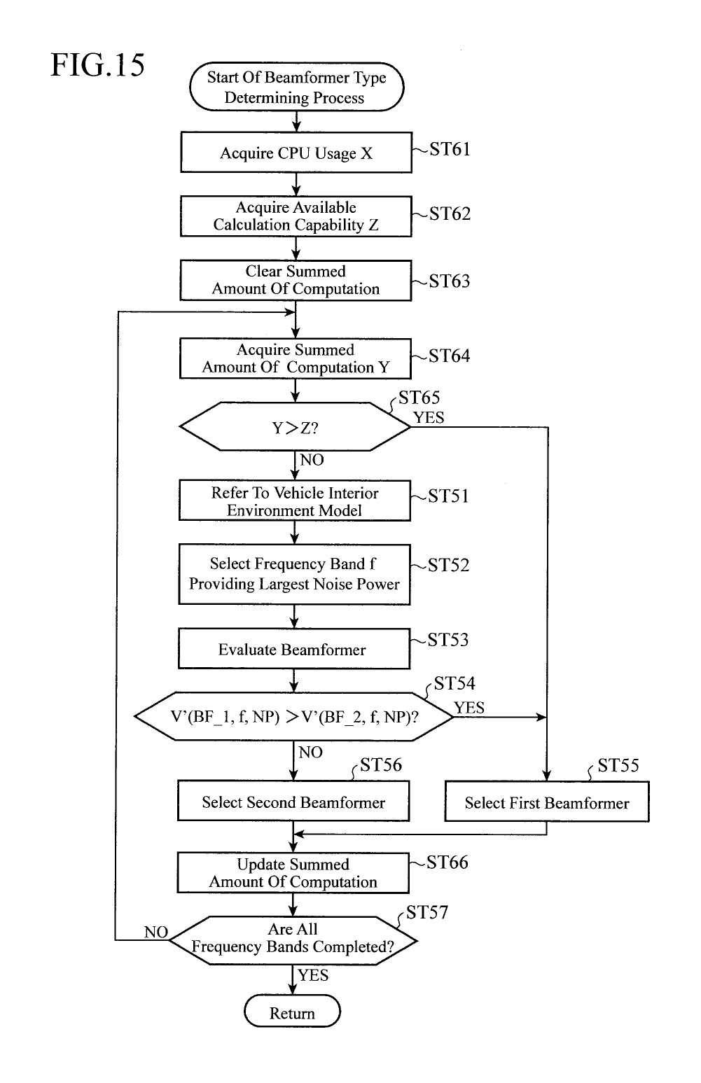

Next, the details of a beamformer type determining process will be explained with reference to a flow chart shown in FIG. 15. This process corresponds to step ST3 shown in FIG. 2. Because processes of steps ST51 to ST57 shown in FIG. 15 are the same as those of steps ST51 to ST57 shown in FIG. 12, the explanation of the processes will be omitted hereafter, and processes of steps ST61 and ST66 will be explained mainly. First, the load conditions acquiring unit 21 acquires the CPU usage X (step ST61).

Next, the beamformer type determining unit 14 acquires the available calculation capability of the beamformer group which corresponds to the CPU usage X outputted from the load conditions acquiring unit 21 with reference to the available calculation capability table 136 stored in the vehicle interior environment model storage unit 13c, and expresses the available calculation capability as an available calculation capability Z (step ST62). The beamformer type determining unit 14 also clears the summed amount of computation which the amount of computation summing unit 20 stores (step ST63).

The beamformer type determining unit 14 refers to the amount of computation summing unit 20 to acquire the current summed amount of computation and expresses this current summed amount of computation as a summed amount of computation Y (step ST64). Because the summed amount of computation has just been cleared in the previous step ST63 when the step ST64 is carried out for the first time, the summed amount of computation Y is 0. The beamformer type determining unit then compares the summed amount of computation Y with the available calculation capability Z (step ST65), and, when the summed amount of computation Y is larger than the available calculation capability Z (when “YES” in step ST65), selects the first beamformer 16 which provides the lowest calculation cost (step ST55).

As a result, when the CPU load is high, the beamformer type determining unit can select the beamformer which provides the lowest calculation cost. In contrast, when the summed amount of computation Y is equal to or smaller than the available calculation capability Z (when “NO” in step ST65), the beamformer type determining unit 14 refers to the vehicle interior environment model storage unit 13c to determine the beamformer type which should be applied to the frequency band which provides the largest estimated noise power, among the frequency bands on which the beamformer type determining unit has not carried out the determination yet, according to the equation (6) shown above (steps ST51 to ST56), like that in accordance with above-mentioned Embodiment 4. As a result, when the CPU has a margin of the processing capability, the beamformer type determining unit can select the most suitable beamformer on the basis of not the calculation cost, but the directional characteristics and the estimated noise power.

After carrying out the determination, the beamformer type determining unit 14 adds the amount of computation calculated for the selected beamformer from equation (8) shown below to the summed amount of computation held by the amount of computation summing unit 20 to update the summed amount of computation held by the amount of computation summing unit 20 (step ST66).

Cost(BF)−MinCost (8)

where Cost(BF) is the same as that in the equation (7) shown above, and is a function of returning a corresponding calculation cost to each beamformer type. Further, MinCost corresponds to the calculation cost Cost(BF_{—}1) for the first beamformer 16.

The beamformer type determining unit 14 then carries out the beamformer type determination on signals in frequency bands in descending order of their estimated noise power, and, when completing the beamformer type determination on the signals in all the frequency bands outputted from the BF selector 15 (when “YES” in step ST57), the beamformer type determining unit ends the series of beamformer type determining processes. In contrast, when there is a frequency band on which the determination has not been carried out yet (when “NO” in step ST57), the beamformer type determining unit returns to step ST64 again.

The beamformer type determining unit 14 thus adds the difference between the calculation cost and the minimum cost MinCost which is calculated for each frequency band to the summed amount of computation held by the amount of computation summing unit 20, and switches between the first beamformer 16 and the second beamformer 17 according to a criterion by which to determine what amount of computation is increased as compared with a structure of including only a beamformer having the lowest cost (i.e., the first beamformer 16).

As mentioned above, the target sound enhancement device 10 in accordance with Embodiment 5 is constructed in such a way that the target sound enhancement device includes the amount of computation summing unit 20 for summing the amount of computation caused by the first beamformer 16 and summing the amount of computation caused by the second beamformer 17 for each predetermined frequency band, and the load conditions acquiring unit 21 for acquiring the CPU usage showing the degree of the CPU load, the vehicle interior environment model storage unit 13c stores the calculation cost according to each beamformer type and the information about the available calculation capability which can be assigned to the beamformer group according to the CPU usage, and the beamformer type determining unit 14 acquires the available calculation capability according to the CPU usage, which the load condition acquiring unit 21 has acquired, from the vehicle interior environment model storage unit 13c, and, when the summed amount of computation held by the amount of computation summing part is smaller than the acquired available calculation capability, evaluates the first and second beamformers 16 and 17 on a per predetermined frequency band basis to select one of them, and, when the summed amount of computation is equal to or larger than the available calculation capability, selects the beamformer which provides a lower calculation cost from the first beamformer 16 and the second beamformer 17. Therefore, the target sound enhancement device can switch between the beamformer types according to the load conditions of the target sound enhancement device 10 or the car navigation system 1. Therefore, the target sound enhancement device is applied to a system in which the load conditions easily change, like the car navigation system 1, and is suitable for use in such a system.

Although a Delay and Sum beamformer is used as the first beamformer 16 and a minimum variance distortionless response beamformer is used as the second beamformer 17 in above-mentioned Embodiments 1 to 5, the types of beamformers are not limited to these types, and, for example, a maximum likelihood beamformer, a multi-channel Wiener filter, a generalization side lobe canceler, and the like can be used. Even in a case of this structure, what is necessary is just to evaluate each beamformer by using the directional characteristics, the amount of computation, the SN ability, and so on as the beamformer type determining process. Further, although the target sound enhancement device is constructed in such a way as to include the following two types of beamformers: the first beamformer 16 and the second beamformer 17, the target sound enhancement device can be alternatively constructed in such a way as to include three or more types of beamformers.

While the invention has been described in its preferred embodiments, it is to be understood that, in addition to the above-mentioned structures, an arbitrary combination of two or more of the above-mentioned embodiments can be made, various changes can be made in an arbitrary component in accordance with any one of the above-mentioned embodiments, and an arbitrary component in accordance with any one of the above-mentioned embodiments can be omitted within the scope of the invention.

### INDUSTRIAL APPLICABILITY

As mentioned above, because the target sound enhancement device in accordance with the present invention is constructed in such a way as to switch between beamformer types according to a vehicle interior environment model, the target sound enhancement device is suitable for use in a car navigation system, a vehicle-mounted handsfree call system, etc.

### EXPLANATIONS OF REFERENCE NUMERALS

1 car navigation system, 2 and 3 microphone, 4 handsfree call control unit, 10 target sound enhancement device, 11 FFT operation unit, 12 FFT operation unit, 13, 13a, 13b, and 13c vehicle interior environment model storage unit, 14 beamformer type determining unit, 15 BF selector (output switching unit), 16 first beamformer, 17 second beamformer, 18 signal combining unit, 19 vehicle interior conditions estimating unit, 20 amount of computation summing unit, 21 load conditions acquiring unit, 131 first beamformer directional characteristics, 132 second beamformer directional characteristics, 133 estimated vehicle interior noise power, 134 microphone directional characteristics, 135 beamforming avoidance frequency, 136 available calculation capability table.

1. A target sound enhancement device comprising:
an operation unit for converting output signals from two or more microphones mounted in an interior of a vehicle into signals in a frequency domain;
a beamformer group having two or more different types of beamformers each for generating a signal including an enhanced target sound for each predetermined frequency band from the plural signals in the frequency domain into which the output signals are converted by said operation unit;
a vehicle interior environment model storage unit for holding information about noise characteristics for said each predetermined frequency band in said vehicle interior environment, and information about directional characteristics of each of said beamformers;
a beamformer type determining unit for evaluating each of said beamformers for said each predetermined frequency band on a basis of the directional characteristic and the noise characteristics held by said vehicle interior environment model storage unit to select a beamformer having a highest level of evaluation from said beamformers;
an output switching unit for outputting the signals in the frequency domain into which the output signals are converted by said operation unit in units of said each predetermined frequency band to the beamformer selected by said beamformer type determining unit; and
a signal combining unit for combining the signals in said predetermined frequency bands outputted by said beamformer group.

2. The target sound enhancement device according to claim 1, wherein the vehicle interior environment model storage unit holds noise power, as the noise characteristics in the vehicle interior environment, for each predetermined frequency band in said vehicle interior environment, and the beamformer type determining unit evaluates each of the beamformers for each predetermined frequency band on a basis of the directional characteristics and said noise power of said each of the beamformers held by said vehicle interior environment model storage unit.

3. The target sound enhancement device according to claim 1, wherein the vehicle interior environment model storage unit holds directional characteristics of each of the microphones as the noise characteristics in the vehicle interior environment, and the beamformer type determining unit evaluates each of the beamformers for each predetermined frequency band on a basis of a signal to noise ratio determined from the directional characteristics of said each of the beamformers and the directional characteristics of each of said microphones, which are held by said vehicle interior environment model storage unit.

4. The target sound enhancement device according to claim 1, wherein the vehicle interior environment model storage unit holds information about calculation costs according to the types of the beamformers, and the beamformer type determining unit evaluates each of the beamformers for each predetermined frequency band on a basis of the directional characteristics, the calculation cost, and the noise characteristics of said each of the beamformers which are held by said vehicle interior environment model storage unit.

5. The target sound enhancement device according to claim 2, wherein said target sound enhancement device includes a vehicle interior conditions estimating unit for estimating noise power in the vehicle interior environment by using the output signals of the microphones, and the beamformer type determining unit uses the noise power which said vehicle interior conditions estimating unit estimates instead of the noise power held by the vehicle interior environment model storage unit.

6. The target sound enhancement device according to claim 1, wherein the vehicle interior environment model storage unit holds information about a frequency band that avoids the beamformers from carrying out their processes, the beamformer type determining unit does not select any beamformer when a frequency band which is a target for the evaluation of each of the beamformers corresponds to the frequency band held by said vehicle interior environment model storage unit, and the output switching unit outputs the signal in said frequency band for which no beamformer is selected by said beamformer type determining unit to the signal combining unit without outputting said signal to the beamformer group.

7. The target sound enhancement device according to claim 1, wherein said target sound enhancement device includes an amount of computation summing unit for summing an amount of computation made by the beamformer group for each predetermined frequency band, and a load conditions acquiring unit for acquiring information indicating a degree of calculation load, and wherein the vehicle interior environment model storage unit holds calculation costs according to the types of the beamformers, and information about an available calculation capability which can be assigned to said beamformer group according to said degree of calculation load, the beamformer type determining unit acquires an available calculation capability according to the degree of calculation load acquired by said load conditions acquiring unit from said vehicle interior environment model storage unit, evaluates each of the beamformers and selects a beamformer for said each predetermined frequency band when the summed amount of computation acquired by said amount of computation summing unit is smaller than the acquired available calculation capability, and selects a beamformer having a smallest calculation cost from said beamformer group when the summed amount of computation is equal to or larger than said available calculation capability.

8. The target sound enhancement device according to claim 4, wherein the beamformer type determining unit refers to the noise characteristics held by the vehicle interior environment model storage unit, and evaluates each of the beamformers for each predetermined frequency band in descending order of noise power in the vehicle interior environment.

9. The target sound enhancement device according to claim 1, wherein a fixed beamformer having a smaller calculation cost than an adaptive beamformer is used as at least one beamformer of the beamformer group.

10. The target sound enhancement device according to claim 1, wherein the beamformer group is comprised of a delay and sum beamformer and a minimum variance distortionless response beamformer.

11. A car navigation system comprising:
two or more microphones mounted in an interior of a vehicle;
a target sound enhancement device according to claim 1 for generating a sound signal in which a speaker's voice in the interior of said vehicle is enhanced by using an output signal from each of said microphones as an input; and
a handsfree call control unit for making a handsfree phone call by using the sound signal generated by said target sound enhancement device.
